(19) United States
(12) Patent Application Publication
(10) Pub. No.: US 2005/0141396 A1
(43) Pub. Date: Jun. 30, 2005

(54) Package for light emitting element and process for fabricating same

(75) Inventors: Masanori Hongo, Osaka (JP); Masami Fukuyama, Osaka (JP); Takashi Ogura, Kyoto (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: SANYO ELECTRIC CO., LTD., Moriguchi-shi (JP)

(21) Appl. No.: 11/019,615

(22) Filed: Dec. 23, 2004

(30) Foreign Application Priority Data
Dec. 26, 2003 (JP) 2003-433845
Dec. 26, 2003 (JP) 2003-433846

(51) Int. Cl. G11B 11/00

(52) U.S. Cl. 369/121

(57) ABSTRACT

The present invention provides a package for light emitting element having a base substrate and a frame body mounted on an upper surface of the base substrate to form a cavity for housing a light emitting element therein. The frame body has an inner peripheral surface formed with a first reflecting layer. Furthermore, the base substrate has an upper surface formed with a pair of land layers for mounting the light emitting element thereon. One of the land layers has an outer peripheral portion connected to a lower end portion of the reflecting layer. The other land layer includes an exposure portion exposed on the upper surface of the base substrate, and a buried portion buried inside the base substrate. Further, the base substrate has a second reflecting layer formed below an area exposed on the bottom surface of the cavity.

### BACKGROUND OF THE INVENTION

1. Field of the Invention

The present invention relates to a package for mounting a light emitting element thereon, a light emitting device including the package, and a process for fabricating the package.

2. Description of Related Art

A package for a light emitting element heretofore comprises a base substrate 7 and a frame body 71 each made of ceramic and which are integrally bonded together, as shown in FIG. 10. A cavity for housing the light emitting element 2 therein is formed inside the frame body 71. The frame body 71 has an inner peripheral surface formed with a metallic layer 50 defining an entire periphery of the cavity. Furthermore, the base substrate 7 has an upper surface formed with a pair of land layers 37, 47 to be connected, respectively, to a pair of terminals (a power supply terminal and a grounding terminal) of the light emitting element 2. The land layers 37, 47 are connected, respectively, to a pair of external electrodes 30, 40 arranged on a rear surface of the base substrate 7, by via holes 38, 48 (JP-A No. 232017/2002).

The light emitting element 2 is mounted on a surface of one land layer 47 of the pair of land layers. One terminal of the pair of terminals is connected to the land layer 47 while the other terminal is connected to the other land layer 37 via a wire 21.

With a light emitting device as described, the light emitting element 2 emanates light in all directions. The light emanating forward (upward direction in FIG. 10) keeps traveling forward as it is while the light emanating sideways is reflected off a surface of the metallic layer 50 to change its traveling direction thereby traveling forward. Further, the land layers 37, 47 each serves a function as a reflecting layer, and reflects forward the light emanating from the light emitting element 2.

The light emitting device shown in FIG. 10 has, however, a gap G for electrical insulation and provided between the land layers 37, 47 or between one of the land layers 37, 47 and the metallic layer 50, so that the light emanating from the light emitting element 2 is passed through the gap G to leak into the inside of the base substrate 7. This entails the problem of a low light emitting efficiency.

We have developed a light emitting device comprising a metallic layer 51 defining a cavity 80 of a package 8, a pair of land layers 81, 82 exposed on a bottom surface of the cavity 80, which land layers 81, 82 are further enlarged to surroundings thereof, to provide the light emitting device having no gap between one of the land layers 81, 82 and the metallic layer 51 on the bottom surface of the cavity 80, as shown in FIG. 11 and FIG. 12. The light emitting device has the pair of land layers 81, 82 connected to a pair of external electrodes 84, 86 by via holes 83, 85, respectively.

In the case where the pair of land layers 81, 82 are in contact with the metallic layer 51, a short circuit is provided between the pair of land layers 81, 82. The metallic layer 51 is therefore formed in depth dimension such that its lower end does not reach the land layers 81, 82.

With the light emitting device described, almost all the light emanating from the light emitting element 2 to the bottom surface of the cavity is reflected off the surfaces of the land layer 81, 82 to travel forward. This makes the light emitting device higher in light emitting efficiency than conventionally.

However, the metallic layer 51 and the land layers 81, 82 are away from each other, as described above, so that all of the light emanating sideways from the light emitting element 2 cannot be reflected by the metallic layer 51. Furthermore, the gap between the land layers 81, 82 is indispensable, so that the light emanating from the light emitting element 2 to the gap area cannot be reflected forward. This entails the problem of still failing to obtain a sufficiently high light emitting efficiency.

### SUMMARY OF THE INVENTION

An object of the present invention is to provide a package for a light emitting element for obtaining a sufficiently higher light emitting efficiency than conventionally, and a process for fabricating the same.

The present invention provides a package for a light emitting element comprising a base substrate 11 made of insulation material, a frame body 14 made of insulation material and mounted on an upper surface of the base substrate 11. A cavity 10 for housing the light emitting element therein is formed inside the frame body 14. The frame body 14 has an inner peripheral surface formed with a reflecting layer 5 defining an entire periphery of the cavity 10. The base substrate 11 has an upper surface formed with a pair of land layers 31, 41, each to be connected to a pair of terminals of the light emitting element. The land layers 31, 41 have surfaces exposed on a bottom surface of the cavity 10, and are connected to a pair of external electrodes 3, 4 arranged on the base substrate 11, respectively.

Furthermore, one land layer 41 of the pair of land layers 31, 41 formed on the upper surface of the base substrate 11 extends along the upper surface of the base substrate 11, and has an outer peripheral portion connected to a lower end portion of the reflecting layer 5 thereof. The other land layer 31 comprises an exposure portion 33 exposed on the upper surface of the base substrate 11, a buried portion 34 extending from the exposure portion 33 to its surrounding and buried inside the base substrate 11. The buried portion 34 has an outer peripheral portion extending to a position below a lower end portion of the reflecting layer 5 or extending outwardly beyond the position thereof. The base substrate 11 and the frame body 14 are each made of ceramic or synthetic resin.

With the light emitting device having the light emitting element mounted on the package for the light emitting element, the light emanating sideways from the light emitting element 2 is reflected off a surface of the reflecting layer 5 to travel forward. Incidentally, the reflecting layer 5 is formed on an entire periphery defining the cavity 10 of the package 1, and is formed to a depth dimension wherein a lower end portion of the reflecting layer 5 is in contact with the bottom surface of the cavity 10, so that all the light emanating toward an inner wall of the cavity 10 is reflected off thereof.

The light emanating from the light emitting element 2 to the bottom surface of the cavity 10 is reflected off the surfaces of the land layers 31, 41 to travel forward. In this case, the one land layer 41 extends along the upper surface of the base substrate 11, and has an outer peripheral portion connected to a lower end portion of the reflecting layer 5 thereof, so that there is no gap between the land layer 41 and the reflecting layer 5 and no light therefore passes through the gap.

The other land layer 31 has the buried portion 34 extending from the exposure portion 33 to its surrounding and buried inside the base substrate 11. The buried portion 34 has an outer peripheral portion extending to a position below a lower end portion of the reflecting layer 5 or extending outwardly beyond the position thereof. Therefore the light incident on an area between the exposure portion 33 of the land layer 31 and an end portion of the reflecting layer 5 is reflected forward by the buried portion 34.

Incidentally interposed between the land layer 31 and the lower end portion of the reflecting layer 5 is an insulation layer formed by a surface layer portion of the base substrate 11, so that the land layer 31 is electrically insulated from the reflecting layer 5 to prevent the occurrence of short circuit between the land layers 31, 41.

The package for the light emitting element embodying the present invention has no gap between the reflecting layer and each of the land layers for passing the light therethrough, to thereby obtain a sufficiently higher light emitting efficiency than conventionally.

The present invention provides a process for fabricating the package for the light emitting element, which process has the steps of:
preparing one or more layers of first ceramic green sheets 15, 16 to serve as the base substrate 11,
preparing one or more layers of second ceramic green sheets 17 to serve as the frame body 14, and
bonding the second ceramic green sheet 17 to an upper surface of the first ceramic green sheets 15, 16 to fire the ceramic green sheets.

The step of preparing the first ceramic green sheets 15, 16 comprises:
a first step of forming a pair of metallic layers 36, 46 on an upper surface of a ceramic green sheet 16a to serve as the pair of land layers,
a second step of forming an insulation layer 9 covering a part of the upper surface of the ceramic green sheet 16a, including an area of one metallic layer 36 of the pair of metallic layers 36, 46 and bonded to the second ceramic green sheet, and
a third step of compressing into a thickness direction the ceramic green sheet 16a formed with the insulation layer 9 to flatten the upper surface of the ceramic green sheet 16a.

In the step of preparing the first ceramic green sheets 15, 16 of the process for fabricating the package for the light emitting element of the present invention, the ceramic green sheet 16a is compressed into a thickness direction in the third step to flatten the upper surface of the sheet 16a, to thereby pressing into the surface of the green sheet 16a the metallic layers 36, 46 formed in the first step and the insulation layer 9 formed in the second step. In this case, the area of the metallic layer 36 covered with the insulation layer 9 is pressed by the insulation layer 9, is thereby pressed more deeply by thickness of the insulation layer 9 than the area not covered with the insulation layer 9, and is buried inside the green sheet 16a. The second ceramic green sheet 17 is bonded to the upper surface of the first ceramic green sheets 15, 16 thus obtained to fire these ceramic green sheets, whereby the package for the light emitting element of the present invention is completed.

According to the process described, the package for the light emitting element embodying the present invention can be fabricated with the simple steps without a great change to the conventional production steps.

The present invention provides another package for a light emitting element comprising a base substrate 11 made of insulation material, a frame body 14 made of insulation material and mounted on an upper surface of the base substrate 11. A cavity 10 for housing the light emitting element therein is formed inside the frame body 14. The frame body 14 has an inner peripheral surface formed with a first reflecting layer 5 defining an entire periphery of the cavity 10. The base substrate 11 has an upper surface formed with a pair of land layers 31, 41, each to be connected to a pair of terminals of the light emitting element and which layers are away from each other. The land layers 31, 41 are connected to a pair of external electrodes 3, 4 arranged on the base substrate 11, respectively. The base substrate 11 has a second reflecting layer 6 formed below an area which is not formed with the land layers 31, 41, of areas at least exposed on the bottom surface of the cavity 10. The base substrate 11 and the frame body 14 are each made of ceramic or synthetic resin.

With the light emitting device having a light emitting element mounted on a package for the light emitting element, the light emanating from the light emitting element 2 to a gap area between the land layers 31, 41 passes through the surface layer portion of the base substrate 11, and is, however, reflected off a surface of the second reflecting layer 6 to travel forward. Incidentally the second reflecting layer 6 extends to the area which is not formed with the land layers 31, 41, of the areas at least exposed on the bottom surface of the cavity 10, so that all the light incident on the gap area between the land layers 31, 41 is reflected off without leakage. Further, the second reflecting layer 6 is away from the land layers 31, 41. This prevents the occurrence of short circuit between the land layers 31, 41.

With the package for the light emitting element embodying the present invention, all the light emanating from the light emitting element 2 to the bottom surface of the cavity 10 of the package 1 is reflected off, whereby a sufficiently higher light emitting efficiency than conventionally can be obtained.

### BRIEF DESCRIPTION OF THE DRAWINGS

FIG. 1 is a perspective view of a light emitting device embodying the present invention;

FIG. 2 is a view in cross section of the light emitting device;

FIG. 3 is an enlarged view in cross section of an A portion in FIG. 2;

FIG. 4 is an enlarged view in cross section on a line B-B in FIG. 2;

FIG. 5 is a perspective view of a package;

FIG. 6 is a plan view of the package;

FIG. 7 is an exploded perspective view of the package;

FIG. 8(a) to FIG. 8(c) are diagrams showing a process for fabricating the package;

FIG. 9(a) to FIG. 9(c) are diagrams showing a process for fabricating a green sheet to serve as an upper layer portion of a base substrate;

FIG. 10 is a sectional view of the conventional light emitting device;

FIG. 11 is a sectional view of another conventional light emitting device;

FIG. 12 is a plan view of a package of the light emitting device.

### DETAILED DESCRIPTION OF THE INVENTION

With reference to the drawings, the embodiment of the present invention will be specifically described below.

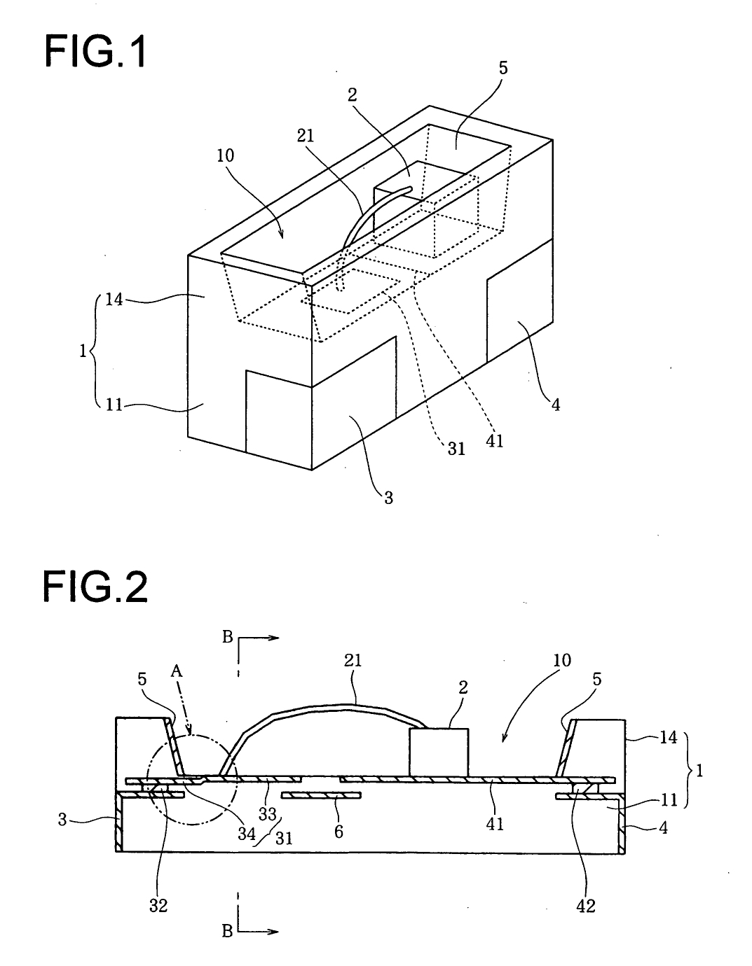

A light emitting device embodying the present invention comprises a ceramic package 1, and a light emitting element 2 including LED and mounted on the package 1, as seen in FIG. 1. The package 1 has a cavity 10 for housing the light emitting element 2 therein. The cavity 10 has a bottom surface formed with a first land layer 31 and a second land layer 41, which are made of conductive material, such as silver, and which are separated from each other. A power supply terminal (not shown) provided on an upper surface of the light emitting element 2 is connected to the first land layer 31 by a wire 21. A grounding terminal (not shown) provided on a rear surface of the light emitting element 2 is directly connected to the second land layer 41. Furthermore, the package 1 has a pair of external electrodes 3, 4 arranged thereon. Referring to FIG. 2, the aforementioned first and the second land layers 31, 41 are connected to the pair of external electrodes 3, 4 by via holes 32, 42, respectively.

With the light emitting device shown in FIG. 1, the external electrodes 3, 4 are mounted, as laid horizontally and facing downward, on a surface of a circuit board. The external electrodes 3, 4 are soldered to a pair of lands on the circuit board. Supplying power from the circuit board to the light emitting element 2 operates the light emitting element 2, to emanate light in all directions.

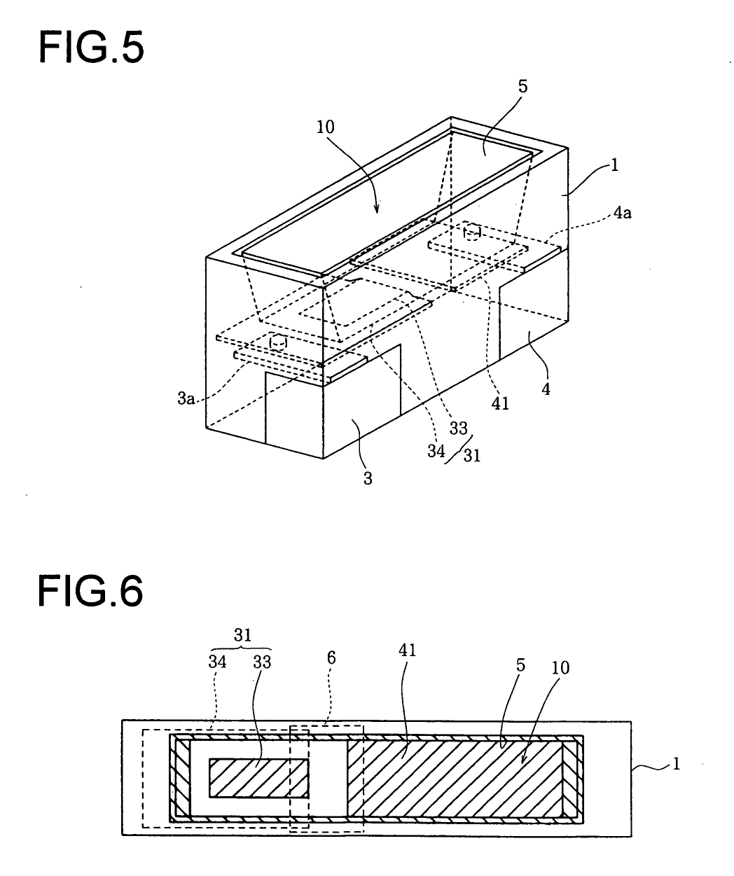

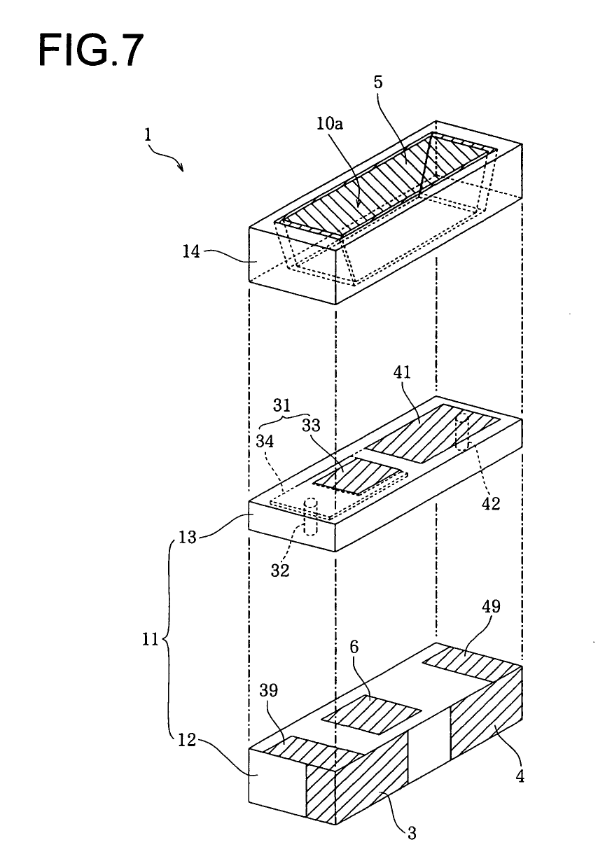

FIG. 7 illustrates a laminate structure of the package 1. As illustrated, a frame body 14 provided with a central hole 10a to serve as the cavity 10 is mounted on an upper surface of a base substrate 11 in the form of a flat plate and including a lower layer portion 12 and an upper layer portion 13, to provide an integrated package 1 shown in FIG. 5 and FIG. 6. Incidentally, for convenience sake, FIG. 6 and FIG. 7 show also by hatching areas in which the metallic layer such as land layers 31, 41 and the external electrodes 3, ⁴, etc., are exposed.

With reference to FIG. 7, the frame body 14 constituting the package 1 has a first reflecting layer 5 made of metal like silver, etc., and formed on an inner peripheral surface of the central hole 10a. The lower layer portion 12 of the base substrate 11 has the pair of external electrodes 3, 4 arranged on the side surface thereof. Formed on the upper surface of the lower layer portion 12 are electrode layers 39, 49 connected to the external electrodes 3, 4, respectively. Furthermore, formed between the electrode layers 39, 49 is a second reflecting layer 6 made of metal like silver, etc.

Furthermore, the upper layer portion 13 of the base substrate 11 has an upper surface formed with the aforementioned first land layer 31 and the second land layer 41, and also has provided with via holes 32, 42 for connecting to each other the land layers 31, 41 and the electrode layers 39, 49 on the upper surface of the lower layer portion 12. The first land layer 31 formed on the upper layer portion 13 of the base substrate 11 comprises an exposure portion 33 which is exposed on the upper surface of the upper layer portion 13, and a buried portion 34 extended from the exposure portion 33 to its surrounding and buried inside the upper layer portion 13. On the other hand, the entire second land layer 41 formed on the upper layer portion 13 extends along an upper surface of the upper layer portion 13. Formed between the first land layer 31 and the second land layer 41 is a gap required for insulation between the two land layers 31, 41.

With reference to FIG. 5 and FIG. 6, the exposure portion 33 of the first land layer 31 is exposed on a bottom surface of the cavity 10 of the package 1, and is away from the first reflecting layer 5 and the second land layer 41 in its surrounding. The buried portion 34 of the first land layer 31 extends outwardly from a lower end portion of the first reflecting layer 5. On the other hand, the second land layer 41 has an outer periphery connected to a lower end portion of the first reflecting layer 5.

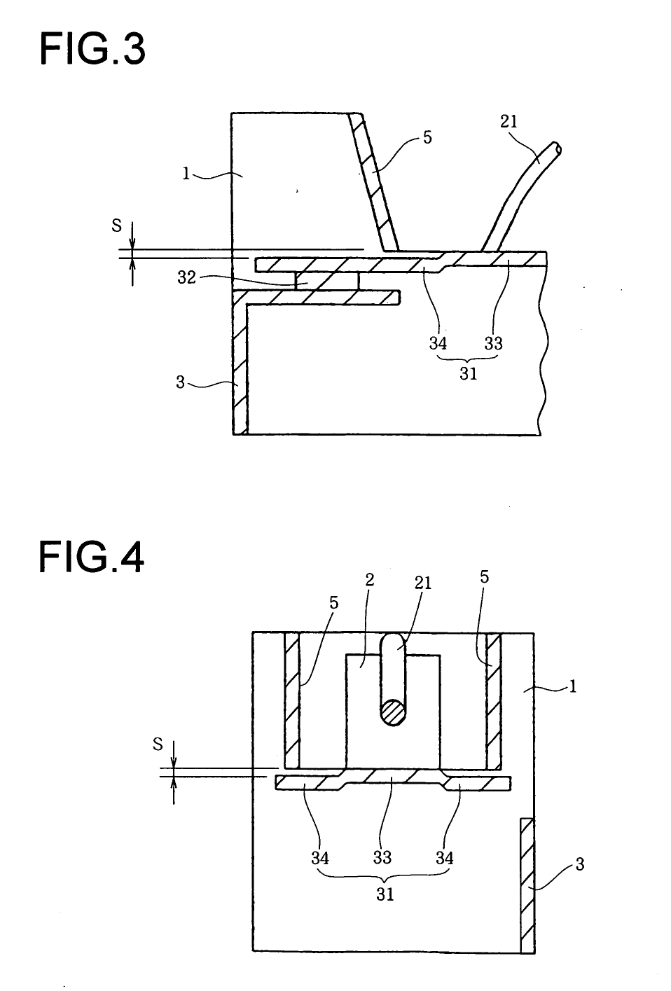

FIG. 3 shows an enlarged view of an A portion in FIG. 2. FIG. 4 shows a sectional view on a line B-B in FIG. 2. As shown in FIG. 3 and FIG. 4, the buried portion 34 of the first land layer 31 extends outwardly from a lower end portion of the first reflecting layer 5 with a slight gap S (10 to 30 μm) thereof from the lower end portion of the first reflecting layer 5.

The second reflecting layer 6 is formed with an area involving a clearance portion formed between the two land layers 31, 41, as shown in FIG. 6, and is buried inside the base substrate 11 as shown in FIG. 2. An insulation layer formed by a surface layer portion of the base substrate 11 is interposed between the second reflecting layer 6 and each of the land layers 31, 41.

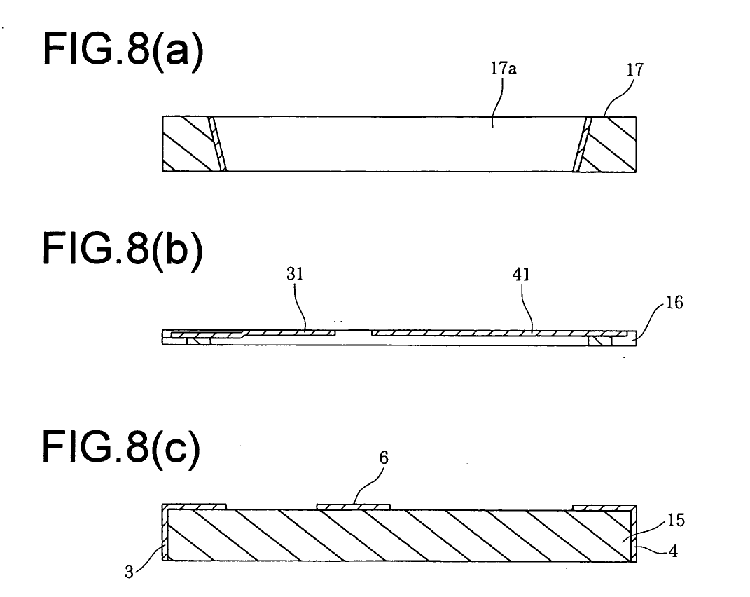

FIG. 8(a) to FIG. 8(c) illustrate production process of the package 1. First prepared are a ceramic green sheet 17 having a through-hole 17a to serve as the frame body 14 as shown in FIG. 8(a), a ceramic green sheet 16 including the first and the second land layers 31, 41 to serve as an upper layer portion 13 of the base substrate 11 as shown in FIG. 8(b), and a ceramic green sheet 15 including the external electrodes 3, 4 and the second reflecting layer 6 to serve as a lower layer portion 12 of the base substrate 11, respectively. Subsequently the three green sheets 15, 16, 17 are bonded together and are fired, whereby an integrally formed package 1 is obtained shown in FIG. 5 and FIG. 6.

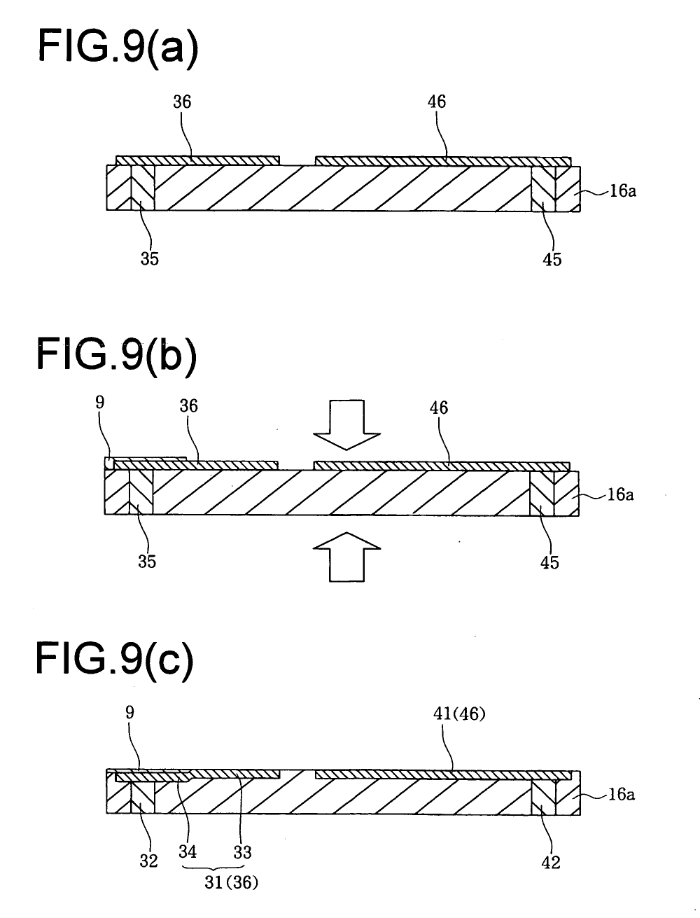

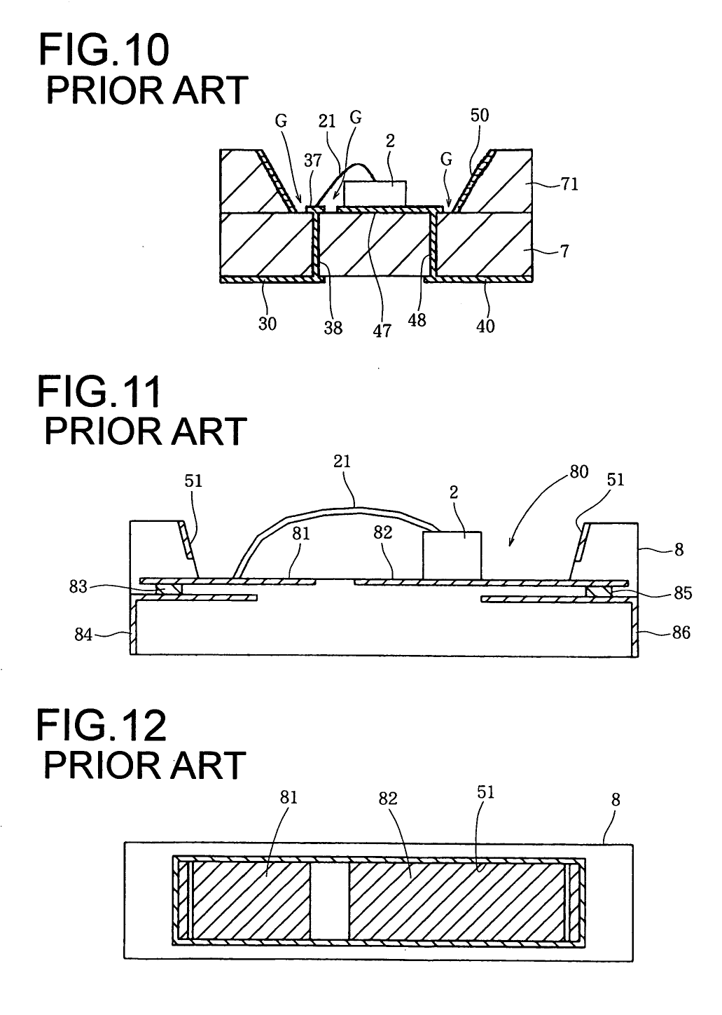

FIG. 9(a) to FIG. 9(c) illustrate production process of the ceramic green sheet 16 shown in FIG. 8(b). Referring to FIG. 9(a), a pair of metallic layers 36, 46 are formed on an upper surface of a ceramic green sheet 16a formed with via holes 35, 45. Subsequently an insulation layer 9 made of overcoat glass is formed to cover an end portion of one metallic layer 36 therewith as shown in FIG. 9(b), and the ceramic green sheet 16 is thereafter compressed in a depth direction, with the result that the metallic layers 36, 46 and the insulation layer 9 are pressed into a surface of the ceramic green sheet 16a to flatten the surface of the green sheet 16a as shown in FIG. 9(c). Incidentally, by being pressed by the insulation layer 9, the area in the metallic layer 36 and covered with the insulation layer 9 is pressed more deeply by thickness of the insulation layer 9 than the area not covered with the insulation layer 9, and is thereby buried inside the ceramic green sheet 16a, to obtain the ceramic green sheet 16 shown in FIG. 8(b). In this case the insulation layer 9 becomes a part of the surface layer portion of the base substrate 11 by firing.

A light emitting element 2 is mounted on the package 1 prepared according to the production steps described as shown in FIG. 1 and FIG. 2, whereby the light emitting device of the present invention is completed.

With the light emitting device, among the light emanating from the light emitting element 2 in all directions, the light incident on the surface of the reflecting layer 5 is reflected off the surface to travel forward (an upward direction in FIG. 1 and FIG. 2). In this case, the reflecting layer 5 has a depth dimension extending to the bottom surface of the cavity 10, so that all the light emanating sideways from the light emitting element 2 is reflected forward.

Further with the light emitting device, among the light emanating from the light emitting element 2 to the bottom surface of the cavity 10, the light incident on the surfaces of the exposure portion 33 of the first land layer 31 and of the second land layer 41 is reflected off the surfaces to travel forward. Furthermore, the light incident on an area between the lower end portion of the reflecting layer 5 and the exposure portion 33 of the first land layer 31 passes through the surface layer portion of the base substrate 11, and is, however, reflected off the surface of the buried portion 34 of the first land layer 31 to travel forward.

Furthermore the light incident on a gap area between the first land layer 31 and the second land layer 41 passes through the upper layer portion 13 of the base substrate 11, and is, however, reflected off the surface of the second reflecting layer 6 to travel forward.

With the light emitting device of the present invention, all the light incident from the light emitting element 2 travels forward as described above, to obtain a sufficiently higher light emitting efficiency than conventionally.

Further, the process for producing the package for the light emitting element embodying the present invention makes it possible to produce the package for the light emitting element of the invention with ease merely by improving a part of the production steps of the green sheets as shown in FIG. 9(a) to FIG. 9(c).

The device of the invention is not limited to the foregoing embodiments in construction but can be modified variously by one skilled in the art without departing from the spirit of the invention as set forth in the appended claims. For example, the package 1 is not limitedly made of ceramic, but can be made of synthetic resin.

1. A package for a light emitting element comprising a base substrate 11 made of insulation material, a frame body 14 made of insulation material and mounted on an upper surface of the base substrate 11, a cavity 10 for housing the light emitting element therein being formed inside the frame body 14, the frame body 14 having an inner peripheral surface formed with a reflecting layer 5 defining an entire periphery of the cavity 10, the base substrate 11 having an upper surface formed with a pair of land layers 31, 41, each to be connected to a pair of terminals of the light emitting element, the land layers 31, 41 having surfaces exposed on a bottom surface of the cavity 10 and being connected to a pair of external electrodes 3, 4 arranged on the base substrate 11, respectively, one land layer 41 of the pair of land layers 31, 41 formed on the upper surface of the base substrate 11 extending along the upper surface of the base substrate 11 and having an outer peripheral portion connected to a lower end portion of the reflecting layer 5 thereof, the other land layer 31 including an exposure portion 33 exposed on the upper surface of the base substrate 11 and a buried portion 34 extending from the exposure portion 33 to its surrounding and buried inside the base substrate 11, the buried portion 34 having an outer peripheral portion extending to a position below a lower end portion of the reflecting layer 5 or extending outwardly beyond the position thereof.

2. A package for a light emitting element according to claim 1, wherein the base substrate 11 and the frame body 14 are each made of ceramic or synthetic resin.

3. A package for a light emitting element according to claim 1, wherein an insulation layer having a thickness of 10 to 30 μm and formed by a surface layer portion of the base substrate 11 is interposed between a lower end portion of the reflecting layer 5 and the buried portion 34 of the other land layer 31.

4. A light emitting device comprising a package 1 and a light emitting element 2 mounted on the package 1, the package 1 including a base substrate 11 made of insulation material, a frame body 14 made of insulation material and mounted on an upper surface of the base substrate 11, a cavity 10 for housing the light emitting element therein being formed inside the frame body 14, the frame body 14 having an inner peripheral surface formed with a reflecting layer 5 defining an entire periphery of the cavity 10, the base substrate 11 having an upper surface formed with a pair of land layers 31, 41, each to be connected to a pair of terminals of the light emitting element 2, the land layers 31, 41 having surfaces exposed on a bottom surface of the cavity 10 and being connected to a pair of external electrodes 3, 4 arranged on the base substrate 11, respectively, one land layer 41 of the pair of land layers 31, 41 formed on the upper surface of the base substrate 11 of the package 1 extending along the upper surface of the base substrate 11 and having an outer peripheral portion connected to a lower end portion of the reflecting layer 5 thereof, the other land layer 31 including an exposure portion 33 exposed on the upper surface of the base substrate 11 and a buried portion 34 extending from the exposure portion 33 to its surrounding and buried inside the base substrate 11, the buried portion 34 having an outer peripheral portion extending to a position below a lower end portion of the reflecting layer 5 or extending outwardly beyond the position thereof.

5. A process for fabricating a package for a light emitting element comprising a base substrate 11 made of insulation material, a frame body 14 made of insulation material and mounted on an upper surface of the base substrate 11, a cavity 10 for housing the light emitting element therein being formed inside the frame body 14, the frame body 14 having an inner peripheral surface formed with a reflecting layer 5 defining an entire periphery of the cavity 10, the base substrate 11 having an upper surface formed with a pair of land layers 31, 41, each to be connected to a pair of terminals of the light emitting element, the land layers 31, 41 having surfaces exposed on a bottom surface of the cavity 10 and being connected to a pair of external electrodes 3, 4 arranged on the base substrate 11, respectively, the process having the steps of:
preparing one or more layers of first ceramic green sheets 15, 16 to serve as the base substrate 11,
preparing one or more layers of second ceramic green sheets 17 to serve as the frame body 14, and
bonding the second ceramic green sheet 17 to an upper surface of the first ceramic green sheets 15, 16 to fire the ceramic green sheets,
the step of preparing the first ceramic green sheets having:
a first step of forming a pair of metallic layers 36, 46 on an upper surface of a ceramic green sheet 16a to serve as the pair of land layers,
a second step of forming an insulation layer 9 covering a part of the upper surface of the ceramic green sheet 16a, including an area of one metallic layer 36 of the pair of metallic layers 36, 46 and bonded to the second ceramic green sheet, and
a third step of compressing into a thickness direction the ceramic green sheet 16a formed with the insulation layer 9 to flatten the upper surface of the ceramic green sheet 16a.

6. A package for a light emitting element comprising a base substrate 11 made of insulation material, a frame body 14 made of insulation material and mounted on an upper surface of the base substrate 11, a cavity 10 for housing the light emitting element therein being formed inside the frame body 14, the frame body 14 having an inner peripheral surface formed with a reflecting layer 5 defining an entire periphery of the cavity 10, the base substrate 11 having an upper surface formed with a pair of land layers 31, 41, each to be connected to a pair of terminals of the light emitting element and which layers are away from each other, the land layers 31, 41 being connected to a pair of external electrodes 3, 4 arranged on the base substrate 11, respectively, the base substrate 11 having a second reflecting layer 6 formed below an area which is not formed with the land layers 31, 41, of areas at least exposed on the bottom surface of the cavity 10.

7. A package for a light emitting element according to claim 6, wherein the base substrate 11 and the frame body 14 are each made of ceramic or synthetic resin.

8. A package for a light emitting element according to claim 6, wherein the base substrate 11 has bonded together a lower layer portion 12 and an upper layer portion 13, the second reflecting layer 6 being formed on a surface on which the lower layer portion 12 and the upper layer portion 13 are bonded together.

9. A package for a light emitting element according to claim 6 wherein one land layer 41 of the pair of land layers 31, 41 formed on the upper surface of the base substrate 11 extends along the upper surface of the base substrate 11 and has an outer peripheral portion connected to a lower end portion of the reflecting layer 5 thereof, the other land layer 31 including an exposure portion 33 exposed on the upper surface of the base substrate 11 and a buried portion 34 extending from the exposure portion 33 to its surrounding and buried inside the base substrate 11, the buried portion 34 having an outer peripheral portion extending to a position below a lower end portion of the reflecting layer 5 or extending outwardly beyond the position thereof.

10. A light emitting device comprising a package 1 and a light emitting element 2 mounted on the package 1, the package 1 including a base substrate 11 made of insulation material, a frame body 14 made of insulation material and mounted on an upper surface of the base substrate 11, a cavity 10 for housing the light emitting element therein being formed inside the frame body 14, the frame body 14 having an inner peripheral surface formed with a reflecting layer 5 defining an entire periphery of the cavity 10, the base substrate 11 having an upper surface formed with a pair of land layers 31, 41, each to be connected to a pair of terminals of the light emitting element 2 and which layers are away from each other, the land layers 31, 41 being connected to a pair of external electrodes 3, 4 arranged on the base substrate 11, respectively, the base substrate 11 of the package 1 having a second reflecting layer 6 formed below an area which is not formed with the land layers 31, 41, of areas at least exposed on the bottom surface of the cavity 10.
